(19) United States
(12) Patent Application Publication
(10) Pub. No.: US 2006/0229034 A1
(43) Pub. Date: Oct. 12, 2006

(54) Ergonomic handheld remote controller

(75) Inventors: Alexander C.M. Gizis, Philadelphia, PA (US); David B. Haynie, Monroeville, NJ (US); Chris Yatsko, Blue Bell, PA (US); Andrew Vellrath, New Castle, DE (US)

Correspondence Address: ECKERT SEAMANS CHERIN & MELLOTT, 600 GRANT STREET, 44TH FLOOR, PITTSBURGH, PA, 15219, US

(73) Assignee: NOMADIO, INC.

(21) Appl. No.: 11/093,230

(22) Filed: Mar. 29, 2005

(51) Int. Cl. H04B 1/034

(52) U.S. Cl. 455/95

(57) ABSTRACT

A handheld controller is for remotely controlling a mobile gaming unit, such as a remote-controlled car. The controller includes a housing having a longitudinal axis, a first controlling mechanism, such as a trigger, for controlling speed and direction of the mobile gaming unit and, a second controlling mechanism including a wheel member for controlling the steering of the mobile gaming unit. In order to provide an ergonomic gripping position, the wheel member is disposed at an angle between about 20 degrees and about 70 degrees, and preferably about 45 degrees, with respect to the longitudinal axis of the housing. The second control mechanism may be set-up in either of a right-handed or left-handed configuration, without requiring a separate intermediate extension member between the second controlling mechanism and the housing. An adjustable display which is pivotal with respect to the housing in order to provide a variable viewing orientation thereof, is also disclosed.

### BACKGROUND OF THE INVENTION

1. Field of the Invention

The invention relates generally to gaming, and more particularly, to handheld controllers for mobile gaming units.

2. Background Information

Mobile gaming units, such as, for example, airplanes, helicopters, and a wide variety of surface vehicles such as boats and cars, for example, are often remote controlled so as to permit a hobbyist to control the vehicle from a remote location (e.g., without limitation, from an elevated platform adjacent a remote control racecar track).

Remote control of such mobile gaming units is generally achieved through the transmission of wireless signals, such as radio waves, from a transmitter, which is held by the hobbyist, to a receiver located at the mobile gaming unit. More specifically, a conventional remote control system, for example, comprises the transmitter, the receiver and a number of servos, disposed within the vehicle. The transmitter, often referred to as the handheld remote controller or simply the controller, is the unit that the hobbyist holds and manipulates in order to transmit outputs or commands, in the form of radio frequency signals, to the receiver in the mobile gaming unit. The receiver then translates the commands into action by sending output signals to actuate the third part of the remote control system, the servos. The receiver, which may include a suitable processor, directs the servos how to move (e.g., in which direction and how far). By way of example, remote control cars typically include at least two servos, one to remotely control the steering of the car, and another to control the speed and forward and reverse directions of the car.

In the case of remote control surface vehicles, such as cars, the controller, as shown schematically in FIG. 1, typically comprises a pistol-grip controller 2 including a grip with a trigger 4 representative of a traditional pistol, and a wheel 6 on one side of the controller 2. The trigger 4 controls the throttle or the speed of the car and whether the car moves in forward or reverse directions. The wheel 6 is somewhat representative of a full size vehicle steering wheel and is, therefore, intended to provide a unique “real” driving control feel as it is manipulated to control the steering of the car.

Pistol-grip controllers (e.g., 2) typically weigh in the neighborhood of about 800 grams and are often used for extended periods of time. For instance, remote control car races can, in some circumstances, last as long as about 4 hours. Such long term use can induce undesirable physical stress on the hobbyist.

Specifically, the wrist 8 of the hand 10 which the hobbyist uses to control the steering wheel 6, is particularly susceptible to fatigue. This is because conventionally, controllers, such as controller 2 shown in FIG. 1, have mounted the wheel 6 in a position which is generally perpendicular with respect to the longitudinal axis 12 of the controller 2, thereby placing the wrist 8 in an unnatural angle (e.g., bent angle of wrist 8 of FIG. 1) as it holds the wheel 6. This awkward and unnatural position applies pressure to the wrist 8 and, as a result, adversely affects the related nerves and arteries passing through the underside of the wrist 8. Repetitive unnatural wrist flexion and pressure applied to the wrist 8, combined with repeated activity of the flexor tendons, can result in repetitive stress disorders. Therefore, correct ergonomic design of the controller 2 is highly desirable.

More recently, in an attempt to address the foregoing concerns and to provide a controller design which is comfortable for extended duration use, some controllers have begun to incorporate a multi-angle wheel extension arm option (not shown). The extension arm comprises a separate assembly including a pivoting mechanism, which allows adjustment of the steering wheel 6 among a variety of positions, and a universal joint. The assembly is disposed between the controller housing and the wheel 6 with the universal joint interconnecting the wheel 6 with the housing in order to provide normal operation of the wheel 6 from any of a variety of positions. However, such assemblies are complex and thus costly. They are also bulky and somewhat awkward, causing the control wheel 6 to be displaced from the housing, thereby creating an undesirable disconnected feel with respect to the remainder of the controller 2. The center of gravity and overall balance of the controller 2 is also affected.

Another ergonomic consideration concerns the display 14 (e.g. without limitation, digital display) that many remote controllers (e.g. 2) have been developed to include. Specifically, controllers 2 that include the display 14 most often position the same such that the plane 16 of the display 14 is generally normal with respect to the longitudinal axis 12 of the controller 2 or alternatively, such that the display 14 is disposed on a side (not shown) of the controller housing generally parallel with the longitudinal axis 12. This presents an unnatural viewing position which requires the hobbyist to either crane his neck or to move the entire controller 2 directly in front of her face, in order to accurately view the display 14.

There is, therefore, room for improvement handheld remote controllers.

### SUMMARY OF THE INVENTION

These needs and others are met by the present invention, which is directed to a handheld remote controller which places the steering wheel and thus the hobbyist's wrist in an ergonomically correct position. In at least one embodiment of the invention, the ergonomical controller of the invention also provides an adjustable display which is pivotal in order to provide variable viewing orientations of the display.

As one aspect of the invention, a handheld controller for remotely controlling a mobile gaming unit comprises: a housing having a longitudinal axis; a first controlling mechanism coupled to the housing and structured to move with respect thereto in order to control at least a first action of the mobile gaming unit; and a second controlling mechanism removably coupled to the housing in order that the handheld controller can be configured in either of a right-handed configuration or a left-handed configuration, the second controlling mechanism being structured to move with respect to the housing in order to control at least a second action of the mobile gaming unit, the second controlling mechanism being disposed at an angle with respect to the longitudinal axis of the housing, the angle being adapted to provide an ergonomic gripping position of the second controlling mechanism.

The handheld controller may be a pistol-grip controller wherein the housing includes a gripping portion which generally resembles a pistol grip and the first controlling mechanism is a trigger, the trigger being structured to control as the at least a first action of the mobile gaming unit, movement and speed of the mobile gaming unit in a forward direction responsive to the trigger being moved toward the gripping portion and, movement and speed of the mobile gaming unit in a reverse direction responsive to the trigger being moved away from the gripping portion. The second controlling mechanism may include a wheel member structured to control as the at least a second action of the mobile gaming unit, steering of the mobile gaming unit. The angle of the wheel member with respect to the longitudinal axis of the housing may be between about 20 degrees and about 70 degrees, and preferably about 45 degrees.

The housing of the pistol-grip controller may include a control section wherein the wheel member is an integral component of the second controlling mechanism and the second controlling mechanism is removably mounted on the control section in order to provide the ergonomic gripping position without requiring a separate intermediate extension member between the second controlling mechanism and the control section.

The housing may include an adjustable display coupled to the housing and structured to pivot with respect to the longitudinal axis of the housing in order to provide a variable viewing orientation. The housing may also include a plurality of control buttons wherein at least one of the control buttons is structured to be identifiable by touch, without having to look at the buttons. The housing may include a base, a control section, and a gripping portion wherein the first and second controlling mechanisms are coupled to the control section and wherein the handheld controller has a weight which is generally equally distributed among the control section, the base, and the gripping portion of the housing.

As another aspect of the invention, a handheld remote controller comprises: a housing having a longitudinal axis; a first controlling mechanism disposed on and moveable with respect to the housing; a second controlling mechanism coupled to the housing at an angle with respect to the longitudinal axis of the housing, the angle being adapted to provide an ergonomic gripping position of the second controlling mechanism; and an adjustable display coupled to the housing, the adjustable display being pivotable with respect to the longitudinal axis of the housing in order to provide a variable viewing orientation of the display.

The angle may be a first angle wherein the adjustable display has a plane and is coupled to the housing by a pivot, which is structured to provide movement of the adjustable display in order that the plane of the adjustable display forms a second angle with respect to the longitudinal axis of the housing, the second angle being adapted to provide a viewing orientation which is ergonomic as the variable viewing orientation. The second angle of the plane of the adjustable display with respect to the longitudinal axis of the housing may be between about 20 degrees and about 70 degrees. The first angle of the second controlling mechanism with respect to the longitudinal axis of the housing and the second angle between the plane of the adjustable display and the longitudinal axis of the housing may be about equal.

As another aspect of the invention, a handheld controller is for remotely controlling a mobile gaming unit. The handheld controller comprises: a housing having a longitudinal axis and including a gripping portion; a first controlling mechanism comprising a trigger coupled to the housing and structured to control a first action of the mobile gaming unit, the first action of the mobile gaming unit including movement and speed of the mobile gaming unit in a forward direction responsive to the trigger being moved toward the gripping portion and, movement and speed of the mobile gaming unit in a reverse direction responsive to the trigger being moved away from the gripping portion; and a second controlling mechanism including a wheel member which is moveable with respect to the housing in order to control at least a second action of the mobile gaming unit, the at least a second action of the mobile gaming unit being steering of the mobile gaming unit, the wheel member being disposed at an angle of between about 20 degrees and about 70 degrees with respect to the longitudinal axis of the housing, the second controlling mechanism being removably coupled to the housing in order that the handheld controller can be set-up in either of a right-handed or a left-handed configuration.

### BRIEF DESCRIPTION OF THE DRAWINGS

A full understanding of the invention can be gained from the following description of the preferred embodiments when read in conjunction with the accompanying drawings in which:

FIG. 1 is a simplified plan view of a pistol-grip remote controller having a display, showing the wrist position of a hobbyist when manipulating the mounted steering wheel and the viewing orientation of the display;

FIG. 2 is a simplified plan view of an ergonomic pistol-grip remote controller having an angled steering wheel and an adjustable display in accordance with the invention;

FIG. 3 is an elevational view of one side of the ergonomic pistol-grip remote controller of FIG. 2 as configured for use by a right-handed hobbyist;

FIG. 4 is a top plan view of the controller of FIG. 3; and

FIG. 5 is an exploded, isometric view of the opposite side of the controller of FIG. 3, but modified to show a configuration for use by a left-handed hobbyist.

### DESCRIPTION OF THE PREFERRED EMBODIMENTS

Directional phrases used herein, such as, for example, left, right, clockwise, counterclockwise and derivatives thereof, relate to the orientation of the elements shown in the drawings and are not limiting upon the claims unless expressly recited therein.

As employed herein, the terms “game” and “gaming” refer to activities engaged in for amusement, as a pastime, a hobby, or to make time pass agreeably.

As employed herein, the term “mobile gaming unit” shall expressly include, but not be limited to, any remote controlled gaming vehicle, remote controlled hobby vehicle, gaming robot, gaming telerobot, toy vehicle, toy tank, toy boat, toy submarine, toy airplane, toy airship, toy aircraft, and toy helicopter.

As employed herein, the term “communication link” shall expressly include, but not be limited to, any point-to-point communication channel or channels, and any communication network.

As employed herein, the term “wireless” shall expressly include, but not be limited by, radio frequency (RF), infrared, wireless area networks, IEEE 802.11 (e.g., 802.11a; 802.11b; 802.11g), IEEE 802.15 (e.g., 802.15.1; 802.15.3, 802.15.4), other wireless communication standards, DECT, PWT, pager, PCS, Wi-Fi, Bluetooth™, and cellular.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

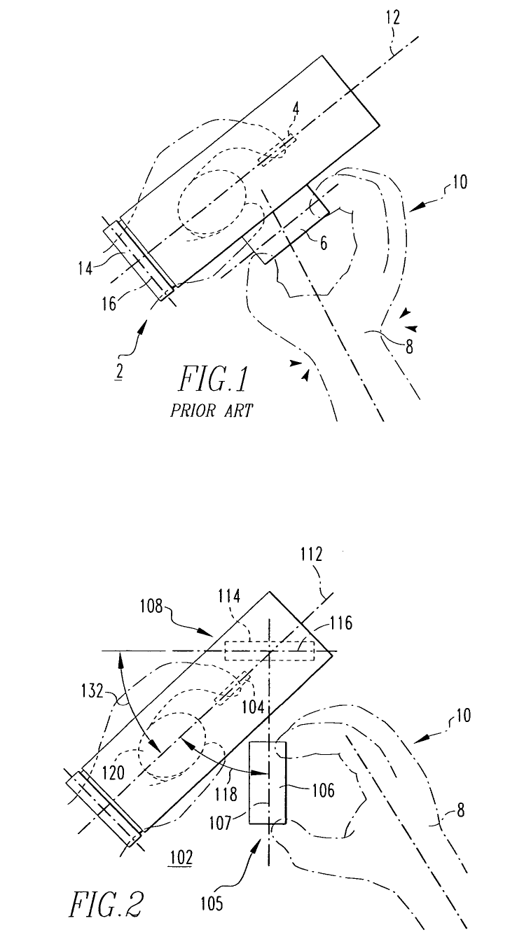

FIG. 2 shows an improved handheld controller 102 in accordance with the invention. For simplicity of disclosure, a simplified, top plan view of the controller 102 is shown. The controller 102 includes a housing 108 having a longitudinal axis 112, a first controlling mechanism 104, and a second controlling mechanism 105 having a wheel member 106. As shown, the wheel member 106 is disposed at an angle 118 with respect to the longitudinal axis 112 of the housing 108 in order to provide an ergonomic gripping position of the second controlling mechanism 105. More specifically, angle 118 between the axis of the wheel member 106 (e.g.; axis 107 of FIG. 2, which is normal to the rotational axis of the wheel member 106) of the second controlling mechanism 105 and the longitudinal axis 112 of housing 108 is adapted to provide a gripping position wherein the hobbyist's wrist 8 is disposed in a generally straight position, as shown. In this manner, awkward wrist positions (e.g., without limitation, bent position of wrist 8 of FIG. 1) and the undesirable physical consequences associated therewith, are substantially avoided. Thus, an ergonomically correct handheld controller 102, which may be comfortably used for an extended period of time, is provided. The angle 118 of the wheel member 106 with respect to the longitudinal axis 112 of the housing 108 is preferably between about 20 degrees and about 70 degrees and more preferably, about 45 degrees.

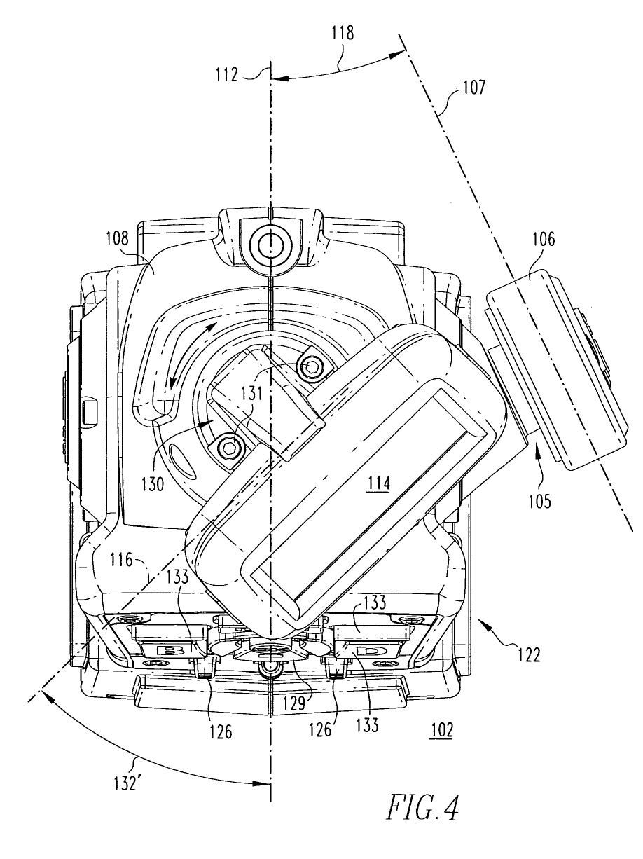

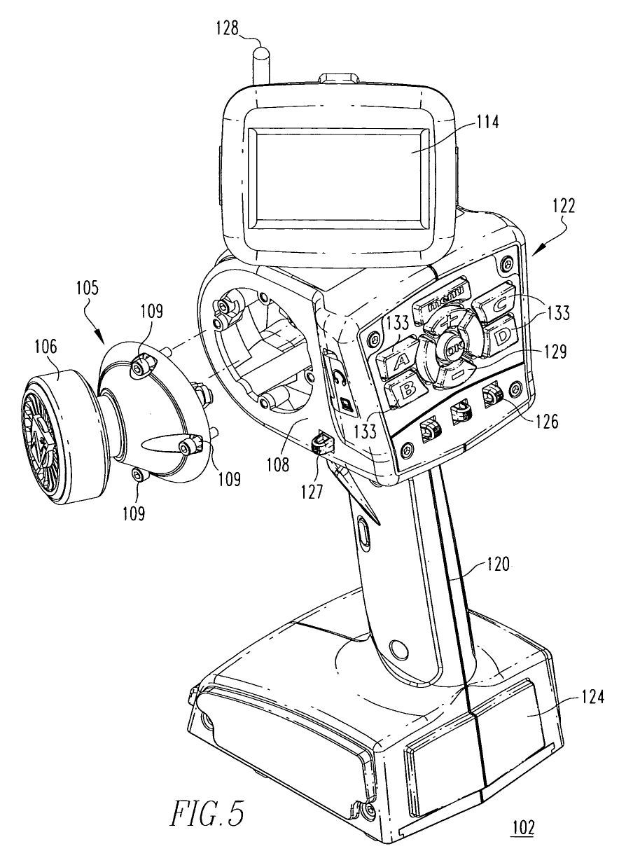

Continuing to refer to FIG. 2, the exemplary handheld controller 102 also includes a display 114, which is coupled to the housing 108. More particularly, the display 114 is an adjustable display structured to pivot with respect to the longitudinal axis 112 of housing 108 in order to provide a variable viewing orientation. In this manner, the adjustable display 114 may be moved (e.g., pivoted) such that the plane 116 of the adjustable display 114 is positioned in a convenient orientation for viewing by the hobbyist. For example, in at least one embodiment of the invention, as shown in FIG. 2, the angle 132 between the plane 116 of the adjustable display 114 and the longitudinal axis 112 of housing 108 is generally equal to the angle 118 between the axis 107 of the wheel member 106 and the longitudinal axis 112 of housing 108. For instance, both of the first and second angles 118,132 in the example of FIG. 2 are preferably about 45 degrees such that the adjustable display 114 is directly in front of the hobbyist's line of sight. It will, however, be appreciated that both the adjustable display 114 and the aforementioned second controlling mechanism 105 and wheel member 106 thereof could be disposed at a wide variety of other angles without departing from the scope of the present invention. For example, angle 132′ of FIG. 4 is less than about 45 degrees.

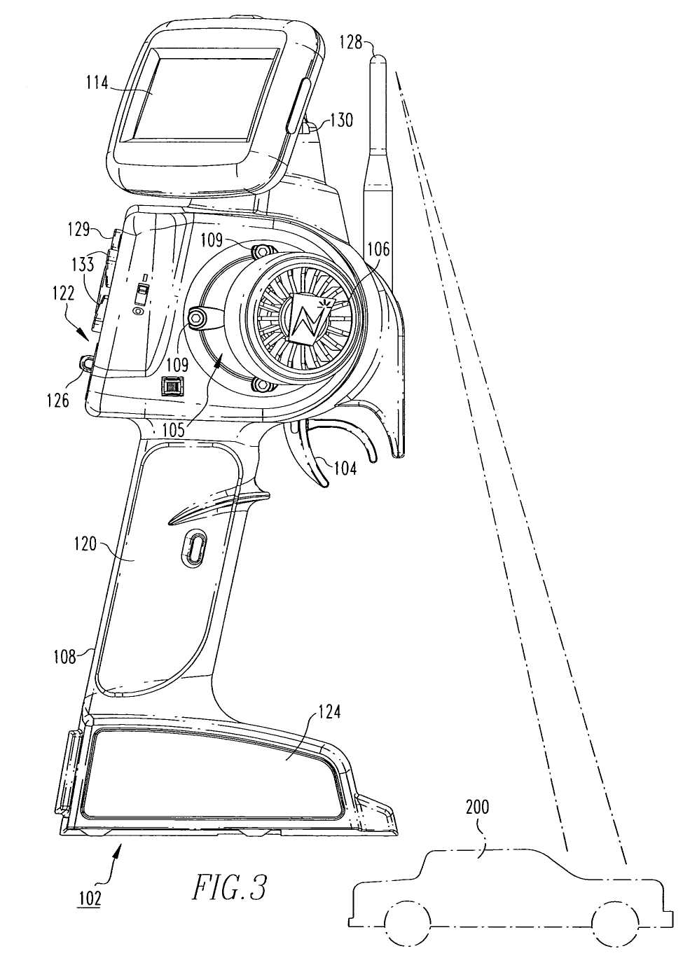

FIG. 3 shows the exemplary handheld controller 102, which is a pistol-grip controller including a gripping portion 120 that generally resembles a pistol grip. The exemplary first controlling mechanism 104 is a trigger which is structured to control a first action, such as movement and speed of a mobile gaming unit 200 (shown in phantom line drawing) in a forward direction (from the perspective of FIG. 3), responsive to the trigger 104 being moved toward the gripping portion 120 and, movement and speed of the mobile gaming unit 200 in a reverse direction (from the perspective of FIG. 3) responsive to the trigger 104 being moved away from the gripping portion 120. The exemplary wheel member 106 of controlling mechanism 105 is structured to pivot clockwise and counterclockwise (from the perspective of FIG. 3) with respect to housing 108, in order to control a second action of the mobile gaming unit (e.g., without limitation, remote control car 200), such as steering.

The pistol-grip controller 102 includes a control section 122 generally disposed above (from the perspective of FIG. 3) the gripping portion 120. The wheel member 106 is an integral component of the second controlling mechanism 105, which is mounted on a side of the control section 122 in order to provide the aforementioned ergonomic gripping position, without requiring a separate intermediate extension member between the second controlling mechanism 105 and the housing 108. In the example of FIG. 3, the second controlling mechanism 105 is coupled to the controlling section 122 by a plurality of fasteners, such as the screws 109 (three screws 109 are shown in FIG. 3). In this manner, the exemplary wheel member 106 is disposed at approximately the same distance from the controller housing 108 as the wheel (e.g., wheel 6 of FIG. 1) of a conventional controller (e.g., controller 2 of FIG. 1), but at the aforementioned desirable ergonomic angle 118 (FIG. 2). Therefore, the overall balance and center of gravity of the controller 102 are not adversely affected by the ergonomic position of the exemplary wheel member 106.

### EXAMPLE

In fact, the exemplary pistol-grip controller 102 may include a base 124 and have a weight of about 800 grams which is generally equally distributed among the control section 122, the gripping portion 120, and the base 124. Accordingly, the controller 102 of the present invention is considered to be well-balanced, which is another desirable attribute for applications where the controller 102 is employed for an extended period of time.

As shown in FIGS. 3-5, the exemplary control section 122 includes at least the adjustable display 114, an antenna 128, and a plurality of control buttons 126,127,129,133. As shown in FIG. 3, the exemplary antenna 128 is preferably a relatively short, non-telescoping antenna designed to resist bending, although a wide range of suitable antennas may be employed. The antenna 128 provides the aforementioned wireless communication with the mobile gaming unit 200.

The control buttons 126,127,129,133 may comprise a wide variety of control elements for both the controller 102 and components of the mobile gaming unit 200, such as the servos (not shown). For example, without limitation, the servos (not shown) which, as previously discussed, control the steering, direction and speed of the mobile gaming unit 200, each have an associated trim button 126 disposed on the controller 102. The controller 102 also has an ON/OFF button 127 and various other buttons such as directional buttons 129 and selection buttons 133 (labeled A, B, C and D in FIG. 5) for programming or otherwise manipulating the controller 102, the mobile gaming unit 200, or various features of the adjustable display 114. In the example shown and described herein, adjustable display 114 is a digital display, although a wide range of suitable displays may be employed. At least one of the aforementioned control elements or control buttons 126,127,129,133 is structured to be identifiable by touch, without having to look at it. For example, selection buttons A, B. C and D (best shown in FIG. 5) are sloped toward one another (e.g., button A is sloped towards button B of FIG. 5) and other buttons (e.g., trim buttons 126) are otherwise shaped such that they are readily identifiable by touch. Accordingly, the buttons 126,127,129,133 and the various associated features of the controller 102 may be actuated without requiring the hobbyist to divert his attention from the mobile gaming unit 200 (FIG. 3).

As best shown in FIG. 4, the exemplary adjustable display 114 is pivotally coupled to housing 108 by a pivot member 130. The pivot member 130 may comprise any known or suitable mechanism for providing pivotal motion of the display 114 with respect to housing 108. The exemplary pivot member 130 is secured to the housing 108 by a plurality of fasteners, such as screws 131 (two screws 131 are shown in FIG. 4). The pivotal member 130, in the example of FIG. 4, permits the adjustable display 114 to, at a minimum, be rotated clockwise and counterclockwise (from the perspective of FIG. 4) with respect to the housing 108. In one embodiment of the invention, the pivot member 130 may include a bearing assembly (not shown) or other suitable mechanism to facilitate such rotation, while in other embodiments no such mechanism is required. Accordingly, the adjustable display 114 of the present invention provides a variable viewing orientation which enables the hobbyist to customize the configuration of the controller 102. Once the adjustable display 114 is set-up in the predetermined position directly in the field of view of the hobbyist, it may be viewed quickly, for example, during a remote control car race. A wide range of information can be shown and viewed on the exemplary digital display 114. For example, without limitation, the digital display 114 may include a clock, a stopwatch or other timer, a lap counter, and a variety of menus and displays (not shown) relating to the configuration (e.g., without limitation, trim) of the mobile gaming unit 200 (FIG. 3).

In the example of FIG. 4, unlike the example previously discussed in connection with FIG. 2, the plane 116 of the adjustable 114 is disposed at an angle 132′ with respect to the longitudinal axis 112 of housing 108, which is slightly different from, rather than equal to, angle 118 between the axis 107 of wheel member 106 and the longitudinal axis 112 of housing 108. This further demonstrates the ability to customize the set-up of the controller 102 of the present invention.

FIG. 5, which shows the pistol-grip handheld controller 102 set-up in a left-handed configuration, further confirms the individually customizable nature of the controller 102. Specifically, unlike the right-handed configuration of the wheel member 106 and adjustable display 114, shown in FIGS. 2-4, the adjustable display 114 and second controlling mechanism 105 and wheel member 106 thereof, are configured in FIG. 5, for a left-handed hobbyist. Accordingly, the present invention provides a handheld controller 102 which is ergonomically designed and which may be customized for comfortable long-term use.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A handheld controller for remotely controlling a mobile gaming unit, said handheld controller comprising:
a housing having a longitudinal axis;
a first controlling mechanism coupled to said housing and structured to move with respect thereto in order to control at least a first action of said mobile gaming unit; and
a second controlling mechanism removably coupled to said housing in order that said handheld controller can be configured in either of a right-handed configuration or a left-handed configuration, said second controlling mechanism being structured to move with respect to said housing in order to control at least a second action of said mobile gaming unit, said second controlling mechanism being disposed at an angle with respect to the longitudinal axis of said housing, said angle being adapted to provide an ergonomic gripping position of said second controlling mechanism.

2. The handheld controller of claim 1 wherein said handheld controller is a pistol-grip controller; wherein said housing includes a gripping portion which generally resembles a pistol grip; wherein said first controlling mechanism is a trigger, said trigger being structured to control as said at least a first action of said mobile gaming unit, movement and speed of said mobile gaming unit in a forward direction responsive to said trigger being moved toward said gripping portion and, movement and speed of said mobile gaming unit in a reverse direction responsive to said trigger being moved away from said gripping portion; and wherein said second controlling mechanism includes a wheel member structured to control as said at least a second action of said mobile gaming unit, steering of said mobile gaming unit.

3. The handheld controller of claim 1 wherein said second controlling mechanism includes a wheel member; and wherein said angle of said wheel member with respect to the longitudinal axis of said housing is between about 20 degrees and about 70 degrees.

4. The handheld controller of claim 3 wherein said angle is about 45 degrees.

5. The handheld controller of claim 3 wherein said handheld controller is a pistol-grip controller; wherein said housing of said pistol-grip controller includes a control section; and wherein said wheel member is an integral component of said second controlling mechanism, said second controlling mechanism being removably mounted on said control section in order to provide said ergonomic gripping position without requiring a separate intermediate extension member between said second controlling mechanism and said control section.

6. The handheld controller of claim 1 wherein said housing includes an adjustable display coupled to said housing and structured to pivot with respect to the longitudinal axis of said housing in order to provide a variable viewing orientation.

7. The handheld controller of claim 1 wherein said housing includes a plurality of control buttons; and wherein at least one of said control buttons is structured to be identifiable by touch, without having to look at said buttons.

8. The handheld controller of claim 1 wherein said housing includes a base, a control section, and a gripping portion; and wherein said first and second controlling mechanisms are coupled to said control section.

9. The handheld controller of claim 8 wherein said handheld controller has a weight which is generally equally distributed among said control section, said base, and said gripping portion of said housing.

10. The handheld controller of claim 8 wherein said control section of said housing includes an antenna.

11. A handheld remote controller comprising:
a housing having a longitudinal axis;
a first controlling mechanism disposed on and moveable with respect to said housing;
a second controlling mechanism coupled to said housing at an angle with respect to the longitudinal axis of said housing, said angle being adapted to provide an ergonomic gripping position of said second controlling mechanism; and
an adjustable display coupled to said housing, said adjustable display being pivotable with respect to the longitudinal axis of said housing in order to provide a variable viewing orientation of said display.

12. The handheld remote controller of claim 1 wherein said handheld remote controller is a pistol-grip controller; wherein said housing includes a gripping portion which generally resembles a pistol-grip; wherein said first controlling mechanism is a trigger which is moveable toward said gripping portion of said housing and away from said gripping portion; and
wherein said second controlling mechanism includes a wheel member.

13. The handheld remote controller of claim 11 wherein said angle of said second controlling mechanism with respect to the longitudinal axis of said housing is between about 20 degrees and about 70 degrees.

14. The handheld remote controller of claim 13 wherein said second controlling mechanism includes a wheel member; and wherein said angle of said wheel member with respect to the longitudinal axis of said housing is about 45 degrees.

15. The handheld remote controller of claim 11 wherein said handheld remote controller is a pistol-grip controller; wherein said housing of said pistol-grip controller includes a control section; and wherein said wheel member is removably coupled to said control section of said housing in order that said pistol-grip controller can be set-up in either of a right-handed configuration or a left-handed configuration.

16. The handheld remote controller of claim 11 wherein said adjustable display is a digital display.

17. The handheld remote controller of claim 11 wherein said angle is a first angle; and wherein said adjustable display has a plane and is coupled to said housing by a pivot, which is structured to provide movement of said adjustable display in order that the plane of said adjustable display forms a second angle with respect to the longitudinal axis of said housing, said second angle being adapted to provide a viewing orientation which is ergonomic as said variable viewing orientation.

18. The handheld remote controller of claim 17 wherein said second angle of the plane of said adjustable display with respect to the longitudinal axis of said housing is between about 20 degrees and about 70 degrees.

19. The handheld remote controller of claim 17 wherein said first angle of said second controlling mechanism with respect to the longitudinal axis of said housing and said second angle between the plane of said adjustable display and the longitudinal axis of said housing are about equal.

20. A handheld controller for remotely controlling a mobile gaming unit, said handheld controller comprising:
a housing having a longitudinal axis and including a gripping portion;
a first controlling mechanism comprising a trigger coupled to said housing and structured to control a first action of said mobile gaming unit, said first action of said mobile gaming unit including movement and speed of said mobile gaming unit in a forward direction responsive to said trigger being moved toward said gripping portion and, movement and speed of said mobile gaming unit in a reverse direction responsive to said trigger being moved away from said gripping portion; and
a second controlling mechanism including a wheel member which is moveable with respect to said housing in order to control at least a second action of said mobile gaming unit, said at least a second action of said mobile gaming unit being steering of said mobile gaming unit, said wheel member being disposed at an angle of between about 20 degrees and about 70 degrees with respect to the longitudinal axis of said housing, said second controlling mechanism being removably coupled to said housing in order that said handheld controller can be configured in either of a right-handed or a left-handed configuration.

21. The handheld controller of claim 21 wherein said angle is about 45 degrees.
